(19) United States
(12) Patent Application Publication
(10) Pub. No.: US 2020/0351236 A1
(43) Pub. Date: Nov. 5, 2020

(54) DISCOVERING A HOST IN A STORAGE NETWORK

(71) Applicant: EMC IP Holding Company LLC, Hopkinton, MA (US)

(72) Inventors: Kishore Ravisankar Alampalli, Bangalore (IN); Ravi Prakash Reddy Mittamida, Bangalore (IN)

(21) Appl. No.: 16/505,974

(22) Filed: Jul. 9, 2019

(30) Foreign Application Priority Data
May 3, 2019 (IN) 201941017873

(51) Int. Cl. H04L 29/12; G06F 16/953; H04L 29/08

(52) U.S. Cl. CPC H04L 61/1511; G06F 16/953; H04L 49/357; H04L 67/1097; H04L 61/1541

(57) ABSTRACT

In embodiments, there is disclosed, systems, methods, and computer program products for discovering a physical host or a virtual host in a storage network comprising: querying a name server database; obtaining from the name server database a port name and a port worldwide number for a port connected to a switch, wherein the switch is part of the storage network; determining using the name server database if the port is, an initiator port or a target port; and for an initiator port, determining using the name server database a host name corresponding to the physical host or virtual host, wherein the physical host or the virtual host is connected to the initiator port.

### BACKGROUND

Storage area networks, such as those found in data centers, can be very complex and typically contain a large number of devices that work together to provide various functions and services to clients. As these networks grow in size and/or become modified due to changing needs and technologies, it becomes challenging to maintain them, as many of these devices are interdependent and must be compatible. For example, suppose an administrator who is responsible for a large data center that is comprised of hundreds of nodes is tasked with introducing new resources to the system. The administrator would need to ensure any new devices, prior to bringing them online to the network, are compatible with the system and are capable of interoperating with existing nodes, both upstream, and downstream, in order to ensure a seamless transition and minimize any impact on the system's performance. With the increasing complexity of today's network systems and devices, managing such a task can be time consuming and labor intensive.

### SUMMARY

This Summary is provided to introduce a selection of concepts in a simplified form that are further described herein in the Detailed Description. This Summary is not intended to identify key features or essential features of the claimed subject matter, nor is it intended to be used to limit the scope of the claimed subject matter.

In embodiments, there is disclosed systems, methods, and computer program products for discovering a physical host in a storage network comprising: querying a name server database; obtaining from the name server database a port name and a port worldwide number for a port connected to a switch, wherein the switch is part of the storage network: determining using the name server database if the port is an initiator port or a target port; and for an initiator port, determining using the name server database a host name corresponding to the physical host, wherein the physical host is connected to the initiator port.

### BRIEF DESCRIPTION OF THE DRAWING FIGURES

Objects, aspects, features, and advantages of embodiments disclosed herein will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features. For clarity, not every element may be labeled in every figure. The drawings are not necessarily to scale, emphasis instead being placed upon illustrating embodiments, principles, and concepts. The drawings are not meant to limit the scope of the claims included herewith.

FIG. 1 is an architectural diagram of a storage ecosystem in accordance with an embodiment;

FIG. 2 is a schematic diagram of potential use cases in accordance with an embodiment;

FIG. 3 is a high-level view of a system architecture for enabling discover of a host in a storage network in accordance with an embodiment;

FIG. 4 is a high-level view architectural view of a portion of a system for enabling discovery of a host in a storage network in accordance with an embodiment;

FIG. 5 depicts content in an exemplary name server database in accordance with embodiments herein;

FIG. 6 depicts an example of some of the information that may be obtained via a REST API run on an name server database in accordance with embodiments;

FIG. 7 is a flow diagram describing a process for discovering a physical host in accordance with embodiments herein; and

FIG. 8 is an example system that can perform at least a portion of the processing described herein.

### DETAILED DESCRIPTION

In order for the physical hosts within a storage area network to work seamlessly together, the a system administrator, whether an individual or an automated function, must be aware of the names and characteristics of the devices within the network. Historically, providing these credentials to system management software or personnel has been, to some extent, a manual function. As will be described in more detail below, it is desirable to automate the discovery of a host so that it remains stitched into the end-to-end configuration of the storage management network. Embodiments described herein provide a mechanism for discovering a physical host or a virtual in a storage area network (SAN) topology.

Before describing embodiments of the concepts, structures, and techniques sought to be protected herein, some terms are explained. The following description includes a number of ills for which the definitions are generally known in the art. However, the following glossary definitions are provided to clarify the subsequent description and may be helpful in understanding the specification and claims.

As used herein, the term “storage area network” (SAN) may refer to a dedicated high-speed network for data storage (e.g., block-level network access to storage). A SAN may be comprised of hosts, switches, storage elements, and storage devices that are interconnected using various technologies, topologies, and protocols.

The term “data center” may refer to physical and/or virtual infrastructures that are used to house computer, server, and networking systems and provide storage, processing, and servicing of large amounts of data to clients.

In some embodiments, the term “storage device” may refer to a storage array including multiple storage devices. In certain embodiments, a storage medium may refer to one or more storage mediums such as a hard drive, a combination of hard drives, flash storage, combinations of flash storage, combinations of hard drives, flash, and other storage devices. and other types and combinations of computer readable storage mediums including those yet to be conceived. A storage medium may also refer both physical and logical storage mediums and may include multiple level of virtual to physical, mappings and may be or include an image or disk image. A storage medium may be computer-readable, and may also be referred to herein as a computer-readable program medium.

In certain embodiments, a storage device may refer to any non-volatile memory (NVM) device, including hard disk drives (HDDs), solid state drives (SSDs), flash devices (e.g., NAND flash devices), and similar devices that may be accessed locally and/or remotely (e.g., via a storage attached network (SAN) (also referred to herein as storage array network (SAN)).

In certain embodiments, a storage array (sometimes referred to as a disk array) may refer to a data storage system that is used for block-based, file-based or object storage, where storage arrays can include, for example, dedicated storage hardware that contains spinning hard disk drives (HDDs), solid-state disk drives., and/or all-flash drives. By way of example, and without limitation, data storage systems that could be used with embodiments described herein include the following products from Dell EMC and additional vendors: Isilon, SC Series, VxFlexOS, Unity, VNX Family, VMAX, POWERMAX, VPLEX, XtremeIO, Atmos, ECS, Centra, Data Domain, Data Protection Advisor, RecoverPoint, Amazon Web Services, Hitachi Data Systems, HP 3PAR, StorageWorks, IBM DS, XIV, SVC, and NetApp FAS. In certain embodiments, a data storage entity may be any one or more of a file system, object storage, virtualized device, a logical unit, a logical unit number, a logical volume, a logical device, a physical device, a block storage system, and/or a storage medium.

In certain embodiment, a host system may refer to a networked computer that provides services to other systems and devices in the network. A switch may refer to a networking device that connects other devices (node-to-node) together in a network. Exemplary switches in network topologies serviced by embodiments include switches made by Dell EMC, Brocade, Cisco and others known in the art.

In certain embodiments, a topology may refer to an arrangement of a network including its nodes and connections.

In certain embodiments, storage resource management (SRM) may refer to one or more processes for optimizing the operation of a storage area network in terms of efficiency and speed with which drive space is utilized.

In certain embodiments a host bus adapter may refer to a device (e.g., an expansion card of a host system) that communicatively connects the host system to peripheral devices (e.g., network and storage devices) in a network.

In some embodiments, non-volatile memory over fabrics (NYMEoF) refers to a specification to enable non-volatile memory message-based commands to transfer data between hosts and targets (solid-state storage) or other systems and networks, such as Ethernet, Fibre Channel (FC) or Infmiband.

While vendor-specific terminology may be used herein to facilitate understanding, it is understood that the concepts, techniques, and structures sought to be protected herein are not limited to use with any specific commercial products. In addition, to ensure clarity in the disclosure, well-understood methods, procedures, circuits, components, and products are not described in detail herein.

The phrases, “such as,” “for example,” “e.g.,” “exemplary,” and variants thereof, are used herein to describe non-limiting embodiments and are used herein to mean “serving as an, example, instance, or illustration.” Any embodiments herein described via these phrases and/or variants are not necessarily to be construed as preferred or advantageous over other embodiments and/or to exclude the incorporation of features from other embodiment& In addition, the word “optionally” is used herein to mean that a feature or process, etc., is provided in some embodiments and not provided in other embodiments.” Any particular embodiment of the invention may include a plurality of “optional” features unless such features conflict.

In embodiments, techniques for discovering a physical host or a virtual host in a storage network are provided. In some aspects, the storage network is managed by a storage resource management tool, which provides a high-level overview of storage network topology. Aspects described herein overcome some of the challenges inherent in physical host or virtual host discovery within storage networks.

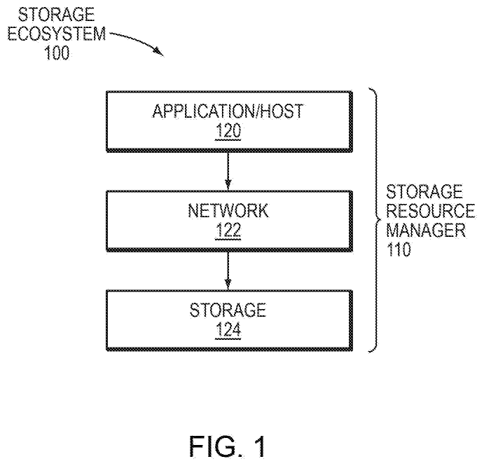

Turning now to FIG. 1, an exemplary storage ecosystem 100 is shown. The ecosystem 100 comprises an application, or host, 120 layer, a network 122 layer, and a storage layer 124. In some embodiments, it is desirable to have an end-to-end management tool, sometimes referred to as storage resource management (“SRM”) 110.

The application layer 120, also interchangeably referred to as a host layer, in embodiments can be an application running on a computer, a server, or other device known to those of skill in the art. In some applications, the application layer 120 supports mobile hosts, virtual hosts, networked hosts, and the like. By way of example, and without limitation, devices/applications existing within the application layer 120 could be Cisco UCS, HP UX, IBM AIX, IBM LPAR, LINUX SUSE, LINUX RHEL. Microsoft Windows, Solaris, VMWare, AppSync, Microsoft Hyper-V, MPIO/PowerPath, Oracle, Microsoft SQL Server, and MYSQL.

The network layer 122 comprises switches. for example, and without limitation, Connectrix Modem SAN, Connectrix B-Series, Connectrix MDS Series, Brocade switches, and Cisco switches. These examples are provided for context and not in any way intended to be limiting with regard to any embodiments described herein.

In embodiments, the storage layer 124 is designed to be flexible in terms of adding or removing storage as needed for capacity, repair and the like. In some scenarios, storage is a resource that can be managed by an enterprise, a group of enterprises, or in some situations provided as a subscription type service.

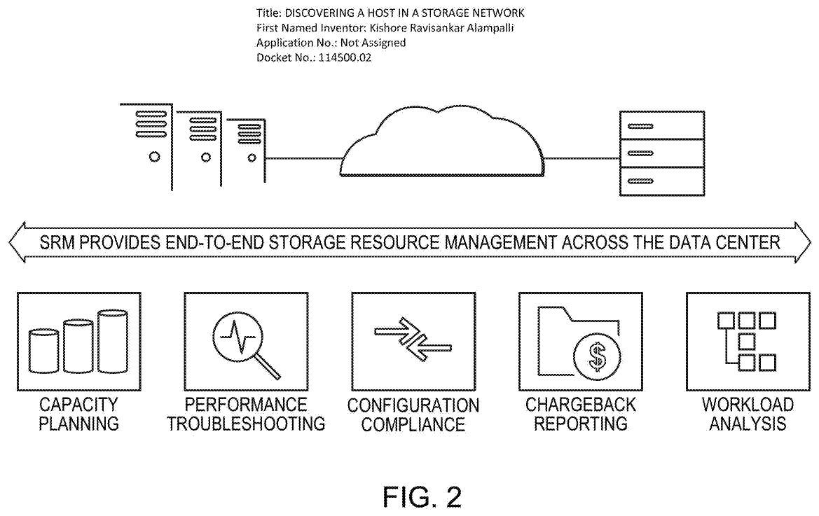

Irrespective of the arrangement, operating a complex storage ecosystem 110 can be enhanced with the additional of a storage resource management 110 tool. FIG. 2 depicts some of the functions a storage resource management tool can bring to bear in enhancing performance of a storage network. In embodiments, an SRM can provide end-to-end storage resource management across the data center.

Storage resource management in embodiments can be a software solution that provides multi-vendor capacity, performance and configuration tools and reports for large scale storage resources. Some SRM embodiments provide relationship and topological views from virtual or physical arrays as well as virtual storage technologies. Performance trends across the data path can assist in understanding the impact traditional and software-defined storage has on applications.

The storage management resource can provide capacity planning, which can rely on historic capacity information to make predictions regarding future requirements. Capacity planning can likewise assimilate future change information to ensure that planned upgrades or changes can adequately be supported from a capacity perspective.

In addition, SRM tools provide performance troubleshooting opportunities. For example. and without limitation, SRM tools can determine if there is a bottleneck in the data pathway at the application layer, the fabric layer, and the storage layer, for example, and without limitation. An SRM tool has visibility into the entire data path.

SRM tools can be utilized for compliance configuration. In embodiments, they have the ability to monitor best practice settings for storage. They can generate alerts if best practices deviate from the desired settings.

SRM tools serve accounting functions in the sense that they can be used in Storage as a Service environments. In these situations, SRM tools provide extensive reporting features enabling them to monetize various features of Storage-as-a-Service, such as storage space, data redundancy, and the like.

In addition, SRM tools provide workload analysis, which can be used to optimize system resources. Load balancing, wear levels and the like can be monitored via workload analysis metrics.

As can be seen, SRM tools enable a high-level view of a data center. In some embodiments, SRM tools take advantage of dashboard displays to allow data center managers visual access to the various reporting metrics encompassed within storage resource management tools.

While the SRM platforms described provide powerful management tools, they are not without challenges. One such challenge is discovering physical hosts or virtual hosts in the application layer 120. By way of example and without limitation, an SRM product created by Dell EMC provides host discovery mechanisms. These host discovery mechanisms, however, require host credentials, which are sometimes not available. In addition, host credentials change frequently. For example, many enterprise security policies require frequent changes of passwords. Each time a password is changed, the host, credentials must be changed. In many data centers, there can be hundreds of thousands of hosts. Keeping track of passwords for each of these hosts can be an arduous task.

When host credentials are not available, some intelligent host discovery algorithms can, be implemented. These features can be referred to as passive host discovery. Passive host discovery works by communicating with switches in the network and extracting information stored thereon about the switch itself and the devices connected to the switch. Passive host discovery can be beneficial because it does not require the administrative burden of tracking credentials for each of the physical hosts or virtual hosts. These passive host discovery techniques can still be burdensome, however, because they require adherence to zone naming patterns, which can be complex in and of itself.

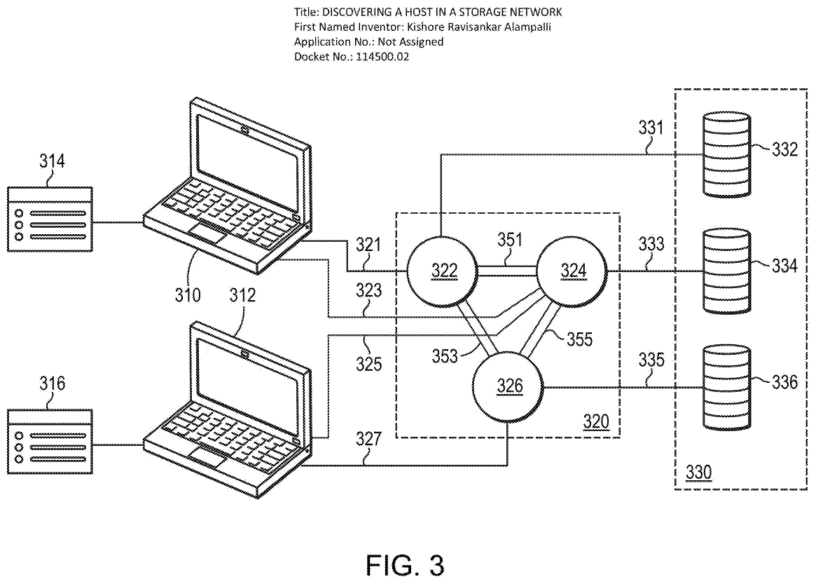

FIG. 3 depicts an architectural overview of a data storage system according to embodiments. For simplicity, there is shown a small number of components. The teachings herein are intended to encompass storage systems having a wide range of scale including those containing many hundreds of thousands of components. The storage area network comprises hosts 310 and 312 upon which applications 314 and 316 are running. Hosts 310 and 312 are interchangeably referred to as servers. Host 310 is connected to switch 322 via host bus 321 and to switch 324 via host bus 323. Host 312 is connected to switch 324 via host bus 325 and to switch 326 via host bus 327. Switches 322, 324, and 326 are connected to via front end adapter ports of storage array 331, 33, 335 to storage devices 332, 334, and 336, respectively.

Of note, FIG. 3 depicts masking aspects of storage. For example, host 310 see storage devices 332 and 334, while storage device 336 is masked to host 310. Similarly, storage device 332 is masked to host 312.

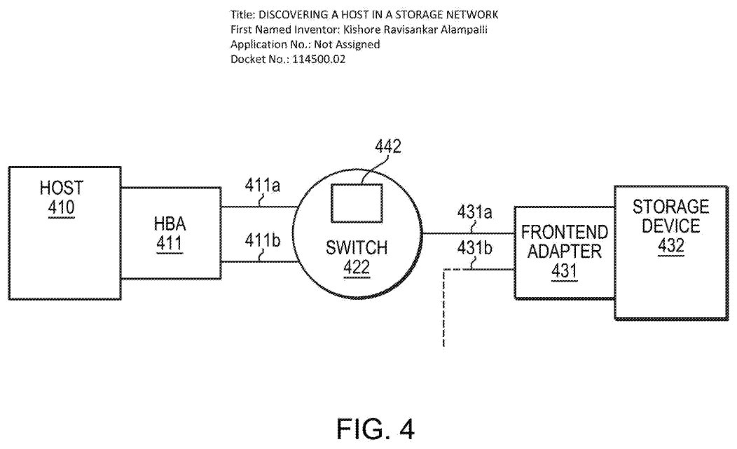

In order to further clarify embodiments herein, there is shown a subset of storage network components in FIG. 4. Turning to FIG. 4, host 410 has host bus adapter 411, which in turn has two host bus adapter (HBA) ports 411a and 411b. HBA ports 411a and 411b are connected to switch 422. Storage device 432 has frontend adapter (FEA) 431, which has two ports, 431a and 431b. FEA 431a is connected to switch 422. When the connections between each of the ports 411a, 411b, 431a and switch 422 are established, each port logs, into switch 422. This is known as port logging.

Once port logging has been accomplished, information related to each of the ports 411a, 411b, and 431a is stored in name server database 442, which is a database hosted on switch 422. In the scenario depicted in FIG. 4, name server database 442 would have three entries, one for each of port 411a, 411b, and 431a. If there were more ports logged into switch 422, name server database 442 would have information for each additional port. Similarly, if less ports were logged in, name server database 442 would have less information. In this situation, name server database 442 could be considered a local name server database because switch 422 is not interconnected with any other switches.

Transferring these concepts back to FIG. 3, which shows a networked architecture, switches 322, 324, and 326 are interconnected via links 351, 353, and 355. When switches 322, 324, 326 are interconnected, they form a fibre channel fabric. In this more complex network, whichever ports are logged into the individual switches, 322, 324, 326, would be captured within the local name server databases on the individual switches, 322, 324, 326. These local name server databases are combined to create a name server database for the entire fabric, meaning for all three switches, 322, 324. 326.

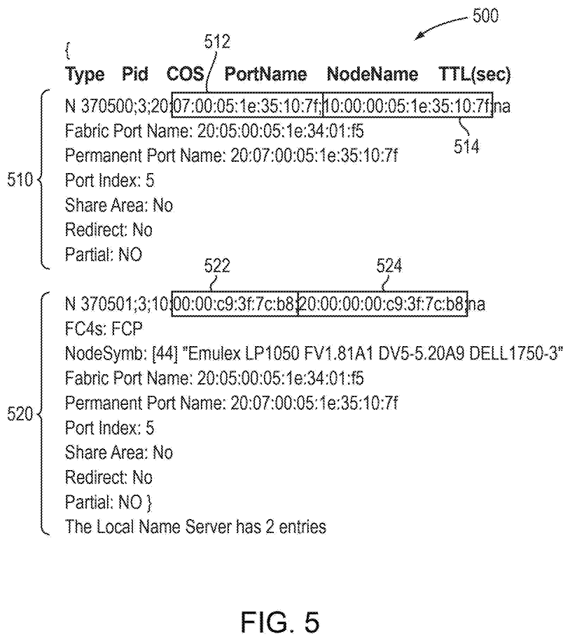

By way of example, and without limitation, an exemplary name server database 500 having two entries may contain information similar to that shown in FIG. 5. As can be seen, name server database 500 contains fields for: the type of port (Type); Process ID; (Pid); Class of Service (COS); Port Name, Node Name, and Time to Leave (TTL). There are two ports 510 and 520 logged into the switching corresponding to name server database 500. First port 510 or second port 520 could be a port corresponding to a host or to a storage device, e.g., 310 or 332. Ports belonging to a host are typically referred to as initiator ports, while posts belonging to storage devices, also called array ports, are referred to as target ports.

First port's worldwide name (WWN) 512 and second ports WWN 522 are part of name server database 500. In addition, first port name 514 and second port name 524 are also part, of name server database 500. Name server database 500 also includes first node name 514 and second node name 524. Node names 514, 524 indicate where the respective ports 512, 522 reside,

Referring to FIG. 4, and specifically to HBA adapter 411, HBA adapter 411 has its own WWN. In embodiments, Node Name 514, 524 can be the WWN for HBA adapter 411. As an example, first port name 512 could correspond to port 411a residing on HBA 411.

In embodiments, it is possible to use a REST API for switch 422 to obtain name server data base information 500. In these embodiments, information being provided on the command line interface output can be used to identify whether a port is an initiator port or a target port.

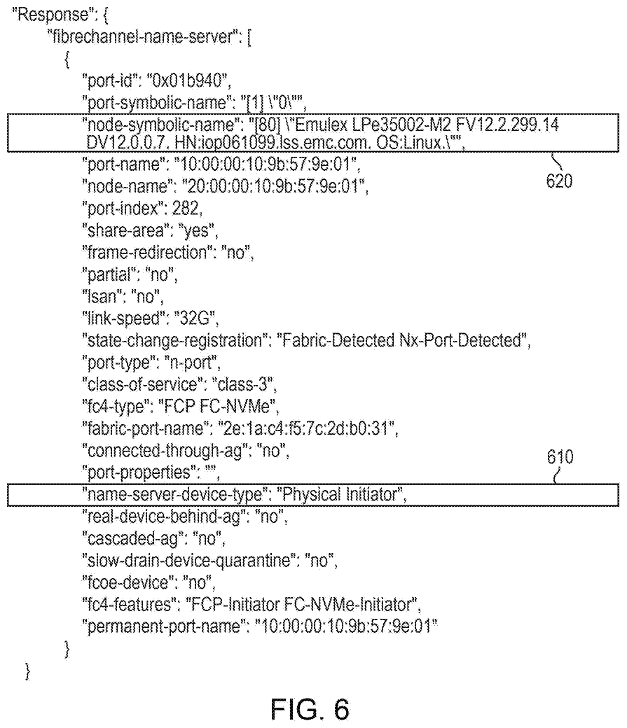

FIG. 6 shows an example of some of the information that may be obtained via a REST API. One of the pieces of information returned from a REST API is name server device type 610, which indicates a port 411 or 431 that is logged into switch 422. In embodiments, name server device type 610 can be used to determine if the port 411, 431 logged into the switch 422 is an initiator port or a target port. In embodiments, initiator ports can be physical initiator ports or virtual initiator ports.

Similarly, target ports can be physical target ports or virtual target ports. Initiator ports are typically used to describe a host 410 port, whereas target ports are typically used to describe an array 430 port. Currently, without using embodiments described herein, the determination of whether a port is an initiator port, or a target port is a tedious exercise that can be error prone due to human intervention. Automating this determination enhances accuracy and efficiency for SRM tools.

In embodiments, the information stored in the name server database information 500 and information returned via a REST API, for example, is routinely updated, and is therefore relatively current. Switch 422 maintains the name server database information 500.

Referring again to FIG. 6, the REST API command can also provide a node symbolic name 620 for initiator ports, which can be used to provide information regarding the node where a specific port resides. This information can be used to ascertain a host name.

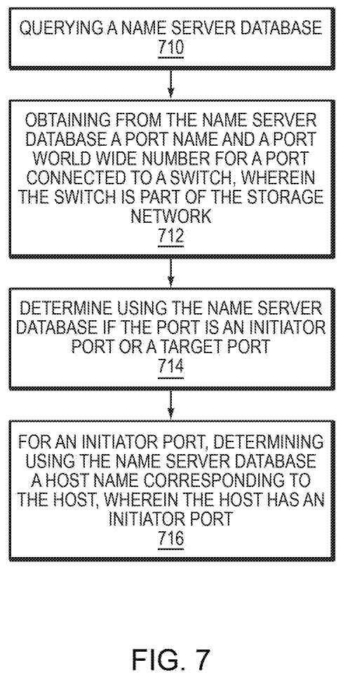

FIG. 7 depicts steps for discovering a physical host or virtual host in a storage network. In embodiments, we query 710 a name server database, which can be stored in a memory. In some embodiments, the name server database can be stored on a switch or in a memory on a switch. In additional embodiments, the switch can be a part of the storage network. After querying 710, we obtain 712 a port name and a port worldwide number for a port connected to a switch, wherein the switch is part of the storage network, from a name server database. We then determine 714, using the name server database, if the port is an initiator port or a target port. If the port is an initiator port, we determine 716 a host name corresponding to the physical host or virtual host we are trying to discovery using the name server database. In embodiments, the physical host or virtual host has an initiator port. In embodiments, the physical host or virtual host is part of the storage network.

In some embodiments, the storage network is managed by a storage resource management tool. This tool can provide myriad functions for end-to-end topology management, as well as discrete management of individual aspects of the storage network.

In embodiments, a masking view may contain an HBA port worldwide number and a list of the volumes or storage arrays that HBA port can access. In additional embodiments, the newly discovered physical host or virtual host can be added to masking views for the storage network topology. In embodiments, this could include associating a storage device to the physical, host or virtual host so that the physical host or virtual host can access the storage device.

In some embodiments, a REST API can be used to obtain one or more pieces of information from the name server database. In embodiments, some of the information obtained from the name server database could include a name server device type or a node symbolic name.

In embodiments, determining if a port is an initiator port or a target port could include analyzing a name server device type. In additional embodiments, determining a host name could include analyzing a node symbolic name.

In large storage networks, or virtual zed environments, networks having various gradations of access to data, or in Storage as a Service applications, to name but a few storage environments, it is desirable to limit data access to authorized users. One means of doing this is to define adjoining patterns. An adjoining pattern can define which hosts see which switches, and, which switches see which storage arrays, for example. This adjoining pattern information is typically assimilated into the storage resource manager.

Once these connections have been established, the storage management resource tool stiches together an end-to-end association of all devices. This information is rendered via user interfaces within the tool to allow administrators to visually manage end-to-end operations in embodiments, Moreover, on the back-end, the connectivity information is used to perform one of more of then functionalities previously described. In many applications, the number of devices stitched together end-to-end numbers in the tens of thousands, hundreds of thousands, or even millions.

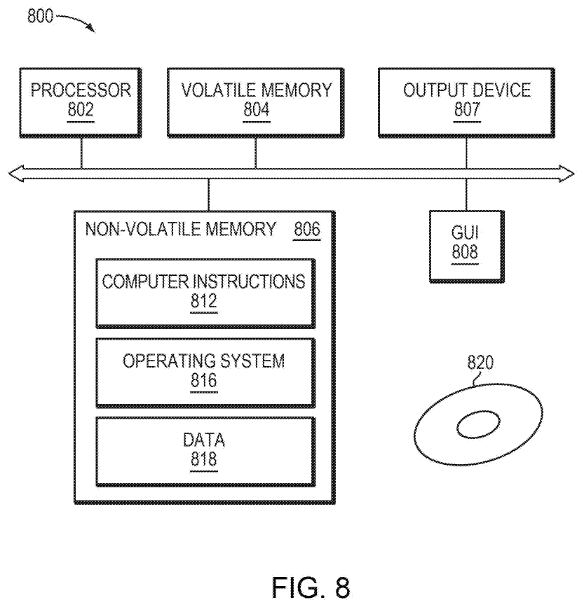

FIG. 8 shows an exemplary computer 800 (e.g., physical or virtual) that can perform at least part of the processing described herein. The computer 800 includes a processor 802, a volatile memory 804, a non-volatile memory 806 (e.g., hard disk or flash), an output device 807 and a graphical user interface (GUI) 808 (e.g., a mouse, a keyboard, a display, for example). The non-volatile memory 506 stores computer instructions 812, an operating system 816 and data 818. In one example, the computer instructions 812 are executed by the processor 802 out of volatile memory 804. The computer instructions perform the functions for embodiments described herein. In one embodiment, an article 820 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by. or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer.

Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

Having described exemplary embodiments of the invention, it will now become apparent to one of ordinary skill in the art that other embodiments incorporating their concepts may also be used. The embodiments contained herein should, not be limited to disclosed embodiments but rather should be limited only by the spirit and scope of the appended claims.

All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable subcombinatiom Other embodiments not specifically described herein are also within the scope of the following claims.

What is claimed, is:

1. A method for discovering a host in a storage network comprising:
querying a name server database;
obtaining from the name server database a port name and a port worldwide number for a port connected to a switch, wherein the switch is part of the storage network;
determining using the name server database if the port is an initiator port or a target port; and
for an initiator port, determining using the name server database a host name corresponding to the host, wherein the host is connected to the initiator port.

2. The method of claim 1 further comprising:
associating a storage device to the host so that the host has visibility to the storage device.

3. The method of claim 1 further comprising:
using a REST API to obtain one or more pieces of information from the name server database.

4. The method of claim 3, wherein the one or more pieces of information is a name server device type or a node symbolic name.

5. The method of claim I, wherein determining if the port is an initiator port or a target port further comprises:
analyzing a name server device type.

6. The method of claim I, wherein determining a host name further comprises:
analyzing a node symbolic name.

7. The method of claim, 1 wherein the storage network is managed by a storage management resources tool.

8. The method of claim 1, wherein the name server database is stored on the switch.

9. A system for discovering a host in a storage network comprising:
a memory comprising computer-executable instructions; and
a processor executing the computer-executable instructions, the computer-executable instructions when executed by the processor cause the processor to perform operations comprising:
querying a name server database;
obtaining from the name server database a port name and a port worldwide number for a port connected to a switch, wherein the switch is part of the storage network;
determining using the name server database if the port is an initiator port or a target port; and
for an initiator port, determining using the name server database a host name corresponding to the host, wherein the host is connected to the initiator port.

10. The system of claim 9, wherein the processor is further configured for associating a storage device to the host so that the host has visibility to the storage device.

11. The system of claim 9, wherein the processor is further configured for using a REST API to obtain one or more pieces of information from the name server database.

12. The system of claim 11, wherein the one or more pieces of information is a name server device type or a node symbolic name.

13. The system of claim 9, wherein determining if the port is an initiator port or a target port further comprises:
analyzing a name server device type.

14. The system of claim 9, wherein determining a host name further comprises:
analyzing a node symbolic name.

15. The system of claim 9, wherein the storage network is managed by a storage management resources tool.

16. The system of claim 9, wherein the name server database is stored on the switch.

17. A non-transitory, computer readable medium comprising code stored thereon that, when executed, performs the following acts:
querying a name server database;
obtaining from the name server database a port name and a port worldwide number for a port connected to a switch, wherein the switch is part of the storage network;
determining using the name server database if the port is an initiator port or a target port; and
for an initiator port, determining using, the name server database a host name corresponding to a host, wherein the host is connected to the initiator port.

18. The non-transitory, computer readable medium of claim 17 further comprising code stored thereon that, when executed. performs the following acts:
associating a storage device to the host so that the host has visibility to the storage device.

19. The non-transitory, computer readable medium of claim 17 further comprising code stored thereon that, when executed, performs the following acts:
using a REST API to obtain one or more pieces of information from the name server database.

20. The non-transitory, computer readable medium of claim 19, wherein the one or more pieces of information is a name server device type or a node, symbolic name.
